(19) United States
(12) Patent Application Publication
(10) Pub. No.: US 2024/0428692 A1
(43) Pub. Date: Dec. 26, 2024

(54) DISPLAYING UAV FLIGHT DATA WITH AUGMENTED REALITY

(71) Applicant: NATIONAL RESEARCH COUNCIL OF CANADA, Ottawa (CA)

(72) Inventor: Jean-Francois LAPOINTE, Gatineau (CA)

(21) Appl. No.: 18/213,358

(22) Filed: Jun. 23, 2023

(51) Int. Cl. G08G 5/00; B64U 10/13; G06T 11/60; H04N 5/272; H04N 7/18

(52) U.S. Cl. CPC G08G 5/0026; B64U 10/13; G06T 11/60; G08G 5/0069; H04N 5/272; H04N 7/183; B64U 2101/30; B64U 2201/20

(57) ABSTRACT

Flight data of an unmanned aerial vehicle or UAV is determined while the unmanned aerial vehicle is under control of a surface-based pilot. An overlay that describes the flight data is generated. The overlay may present operational data, such as altitude and speed; video, such as captured from a camera at the UAV; or a combination of such. The overlay combined with a real view of the unmanned aerial vehicle is displayed to the surface-based pilot.

### FIELD

The present disclosure related to unmanned aerial vehicles and drones.

### BACKGROUND

Unmanned aerial vehicles or drones are useful for flights that do not require an onboard human pilot or passengers. Such vehicles may be used for photography, videography, inspection, delivery, among other uses. A pilot who remains on the ground may control the flight while watching the vehicle in the sky.

### SUMMARY

According to an aspect of the present disclosure, a non-transitory machine-readable medium includes instructions that, when executed by one or more processors, cause the one or more processors to collectively determine flight data of an unmanned aerial vehicle that is controllable by a surface-based pilot, generate an overlay that describes the flight data, and display to the surface-based pilot the overlay combined with a real view of the unmanned aerial vehicle.

The instructions may further to render the flight data as a graphic, symbol, text, or combination of such.

The flight data may include a remaining energy of the unmanned aerial vehicle, an altitude of the unmanned aerial vehicle, a latitude of the unmanned aerial vehicle, a longitude of the unmanned aerial vehicle, or a combination of such.

The flight data may include video captured by a camera of the unmanned aerial vehicle, and the instructions may further display the video combined with the real view of the unmanned aerial vehicle.

The video may include a bird's eye view of the unmanned aerial vehicle.

The video may be taken from a perspective of the unmanned aerial vehicle.

The instructions may cause the one or more processors to collectively generate the overlay with the flight data at a top-left position within the real view.

The instructions may cause the one or more processors to collectively generate the overlay with the flight data at a top-right position within the real view.

The instructions may cause the one or more processors to collectively render a portion of flight data as a graphic, symbol, text, or combination of such at one of a top-left position and a top-right position within the real view, and render another portion of the flight data as video at another of the top-left position and the top-right position within the real view.

The instructions may cause the one or more processors to collectively generate the overlay in which the flight data occupies less than one quarter of the real view.

According to another aspect of the present disclosure, a device includes a communications interface and one or more processors connected to the communications interface. The one or more processors are configured to collectively determine flight data of an unmanned aerial vehicle that is controllable by a surface-based pilot, generate an overlay that describes the flight data, and output the overlay for combination with a real view of the unmanned aerial vehicle.

The flight data may include a remaining energy of the unmanned aerial vehicle, an altitude of the unmanned aerial vehicle, a latitude of the unmanned aerial vehicle, a longitude of the unmanned aerial vehicle, or a combination of such. The one or more processors may be configured to collectively render the flight data as a graphic, symbol, text, or combination of such.

The flight data may include video captured by a camera of the unmanned aerial vehicle. The one or more processors may be configured to collectively display the video combined with the real view of the unmanned aerial vehicle.

The communications interface may include a wireless communications interface. The wireless communications interface may be configured to receive the flight data from the unmanned aerial vehicle.

The device may further include a display device connected to the one or more processors. The display device may be configured to display the overlay combined with the real view of the unmanned aerial vehicle.

The one or more processors may be configured to move the overlay within the real view.

The device may further include a camera connected to the one or more processors. The one or more processors may be configured to detect a gesture of the surface-based pilot using the camera and to move the overlay within the real view based on the gesture.

According to another aspect of the present disclosure, a method includes determining flight data of an unmanned aerial vehicle while the unmanned aerial vehicle is under control of a surface-based pilot, generating an overlay that describes the flight data, and displaying to the surface-based pilot the overlay combined with a real view of the unmanned aerial vehicle.

The flight data may include a remaining energy of the unmanned aerial vehicle, an altitude of the unmanned aerial vehicle, a latitude of the unmanned aerial vehicle, a longitude of the unmanned aerial vehicle, or a combination of such. The method may further include rendering the flight data as a graphic, symbol, text, or combination of such.

The flight data may include video captured by a camera of the unmanned aerial vehicle. The method may further include displaying the video combined with the real view of the unmanned aerial vehicle.

### BRIEF DESCRIPTION OF THE FIGURES

FIG. 1A is a diagram of an example system with an unmanned aerial vehicle and a headset to display flight data thereof according to the present disclosure.

FIG. 1B is a diagram of an example system with an unmanned aerial vehicle and a headset with a computer to display flight data thereof according to the present disclosure.

FIG. 2 is a flowchart of an example method of displaying flight data of an unmanned arial vehicle according to the present disclosure.

FIG. 3A is a diagram of an example overlay combined with a real view, in which representations of flight data are positioned at a top left of the real view, according to the present disclosure.

FIG. 3B is a diagram of an example overlay combined with a real view, in which representations of flight data are positioned at a top right of the real view, according to the present disclosure.

FIG. 3C is a diagram of another example overlay combined with a real view, in which representations of flight data are positioned at a top left of the real view, according to the present disclosure.

FIG. 3D is a diagram of another example overlay combined with a real view, in which representations of flight data are positioned at a top right of the real view, according to the present disclosure.

FIG. 3E is a diagram of an example overlay combined with a real view, in which representations of flight data are positioned at a top left and a top right of the real view, according to the present disclosure.

FIG. 3F is a diagram of an example overlay combined with a real view, in which representations of flight data are positioned at a top left and a top right of the real view, according to the present disclosure.

FIG. 4 is another example headset computing device to display flight data with a movable overlay according to the present disclosure.

### DETAILED DESCRIPTION

When a surface-based pilot loses sight of the unmanned aerial vehicle (UAV) he/she is controlling, a risky or dangerous situation may emerge. Loss of sight of the UAV may result in the UAV crashing, which may damage property or injure people or animals. Even when crash does not occur, a UAV that is out of pilot sight is difficult or impossible to fly in a controlled or efficient manner. Energy may be wasted in returning the UAV to its desired position or flight path. As such, UAV pilots generally try to keep the UAV in sight at all times during a flight. Some jurisdictions may stipulate this as a requirement to operating a UAV.

A pilot may need to consider flight data to effectively operate the UAV. The pilot may thus momentarily glance at flight data, which may be displayed on a remote control or nearby computer. Looking at flight data may require the pilot to look away from the UAV, for example, by looking down at a readout on the remote control. However, looking away from the UAV, even for a moment, may result in a loss of sight of the UAV resulting in the problems mentioned above.

This disclosure provides techniques to reduce or minimize the need for a pilot to lose visual contact with the UAV to view flight data. Flight data is provided to the pilot via a headset that provides a real view of the UAV. Such augmented reality (AR) display of flight data allows the pilot to keep the UAV in sight while viewing the flight data. Accordingly, UAV flights may be made safer, more efficient, or both.

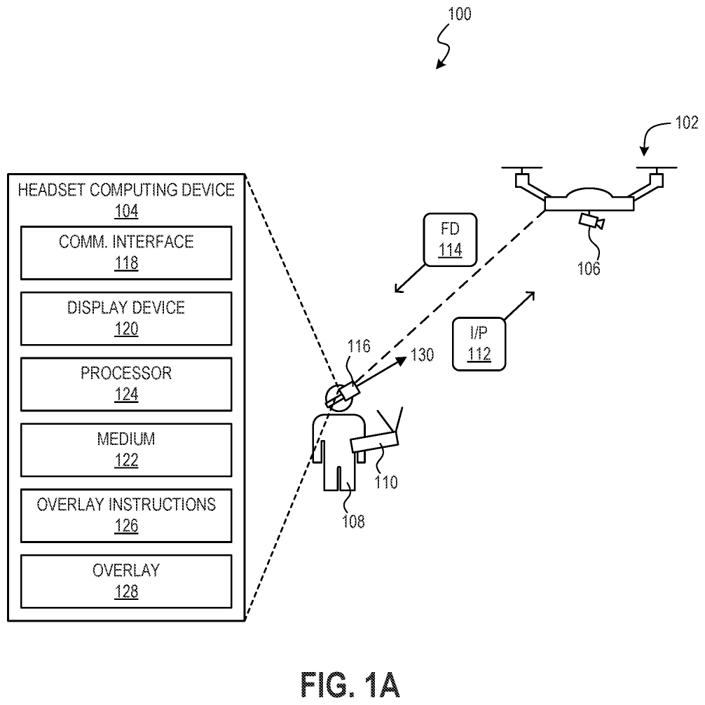

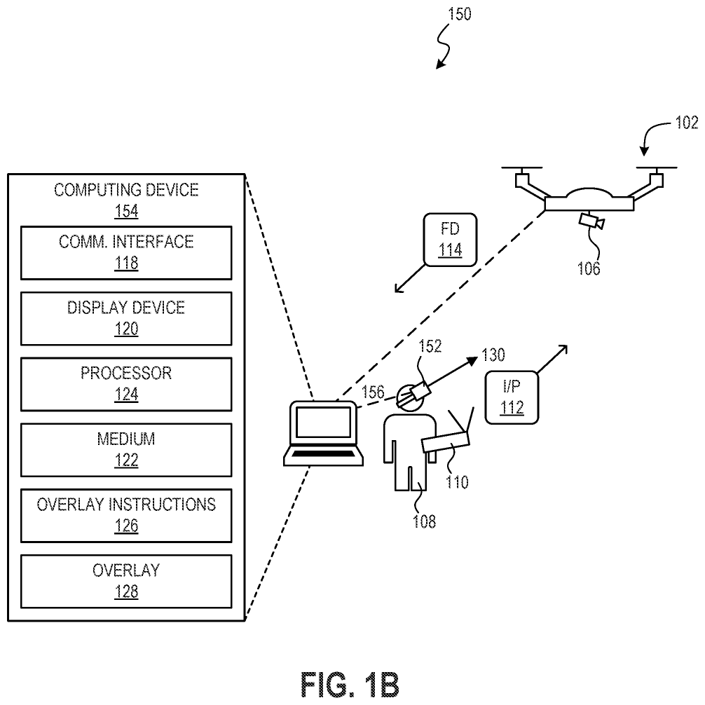

FIG. 1A shows an example system 100 that includes a UAV 102 and a computing device 104.

The UAV 102 includes an airframe, a set of rotors, a power source, a wireless communications interface, and a controller configured for human-controlled, semi-autonomous, or fully autonomous flight. The UAV 102 may include additional components, such as a camera 106, which may be fixed or aimable. The camera 106 may capture digital video from the perspective of the UAV 102. Alternatively or additionally, the camera 106 or an array of cameras 106 may obtain digital video with a bird's eyes view of the UAV 102. The UAV 102 may be referred to as a drone.

The computing device 104 is remote from the UAV 102 and is used by a surface-based pilot 108, who may use a remote control 110 to fly the UAV 102. The surface-based 108 pilot may be positioned on a surface, such as the ground or the surface of a body of water, or may be positioned on a structure or vehicle on such a surface, such as a truck bed, boat, rooftop, or similar. Input signals 112 to control the flight of the UAV 102 may be wirelessly transmitted to the UAV 102 by the remote control 110.

The computing device 104 receives output signals from the UAV 102 via wireless communications. Output signals may represent flight data 114 to aid the pilot 108 in flying the UAV 102. Flight data 114 may be received by the computing device 104 directly from the UAV 102. Alternatively, flight data 114 may be receive from the remote control 110, which receives the flight data 114 from the UAV 102.

In this example, the computing device 104 takes the form of a headset that may be worn by the pilot 108 to view the flight data 114.

The headset computing device 104 incudes a housing 116, a communications interface 118, a display device 120, a non-transitory machine-readable medium 122, and one or more processors 124. The headset computing device 104 may be a commercially available augmented reality or AR headset adapted to implement the functionality discussed herein.

The housing 116 contains and secures the other components of the headset computing device 104 and includes a strap, harness, eyeglass-style arms, or other securing structure to hold the headset 104 to the pilot's head.

The communications interface 118 includes hardware, such as a network adaptor card, network interface controller, or network-capable chipset, and may further include instructions, such as a driver and/or firmware. The communications interface 118 may include an antenna and may be configured for wireless communications with a like communications interface at the UAV 102. The communications interface 118 may be configured to receive the flight data 114 from the UAV 102, directly or indirectly.

The display device 120 may include a light-emitting diode (LED) display, liquid crystal display (LCD), or similar device capable of rendering images for viewing by the pilot 108. The display device 120 may include a transparent screen or other type of optical look-through device that provides an optical real view. Optical look-through may be directly through the screen or aided by optical components, such as a lens, mirror, etc. Alternatively, the real view may be captured by a camera installed at the headset computing device 104 aimed in the direction of the wearer's view and rendered to the wearer with the display device 120. The display device 120 configured to provide combined generated imagery with a real view may be referred to as an augmented reality or AR.

The non-transitory machine-readable medium 122 may include an electronic, magnetic, optical, or other physical storage device that encodes instructions. The medium 122 may include, for example, random access memory (RAM), read-only memory (ROM), electrically-erasable programmable read-only memory (EEPROM), a field-programmable gate array (FPGA) flash memory, a storage drive, an optical device, or similar. The medium 122 may include non-volatile memory, volatile memory, or a combination of such.

The non-transitory machine-readable medium 122 stores instructions that, when executed by one or more processors 124, cause the one or more processors 124 to collectively perform the functionality discussed herein.

The one or more processors 124 includes a central processing unit (CPU), a microprocessor, a processing core, an FPGA (e.g., the processor and medium may be the same device), an application-specific integrated circuit (ASIC), or a similar device capable of executing the instructions. The terms “a” and “the” processor, as used herein, mean one or more processors that collectively execute instructions. “One or more processors” will be referred to as “the processor” for sake of brevity. When multiple processors are used, one process may execute some instructions and another processor may execute other, different instructions.

The processor 124 is connected to the communications interface 118, display device 120, and non-transitory machine-readable medium 122.

Overlay instructions 126 are provided to carry out the functionality discussed herein. Instructions 126 may be directly executed, such as a binary file, and/or may include interpretable code, bytecode, source code, or similar instructions that may undergo additional processing to be executed.

The overlay instructions 126 determine flight data 114 of the UAV 102, generate an overlay 128 that describes the flight data 114, and outputs the overlay 128 for combination with a real view 130 of the UAV 102. The real view 130 is expected to contain the UAV 102 in that the pilot 108 is expected to keep the UAV 102 within his/her view at most or all times during flight. As such, the overlay 128 of flight data 114 provides the pilot 108 with important information without the pilot having to take his/her eyes off the UAV 102.

Determining the flight data 114 may include wirelessly receiving flight data 114 from the UAV 102. The flight data 114 may be used by the instructions 126 as received or may undergo processing by the headset computing device 104.

Flight data 114 may include operational data of the UAV 102, such as remaining energy (e.g., battery charge remaining), altitude, latitude, longitude, or a combination of such. Alternatively or additionally, flight data 114 may include video from a camera 106 installed at the UAV 102. Flight data 114 is selected to provide critical flight operations information to the pilot 108 while reducing or eliminating cognitive overload.

Generating the overlay 128 may include rendering the flight data 114 as a graphic, symbol, text, or combination of such. Example graphics include lines, bars, rectangles, triangles, circles, circular sectors, and other shapes. Example symbols include letters, numbers, characters, and similar. Example text includes strings of human-readable text, which may include words, phrases, and so on. Example overlay elements that combine graphics, symbols, and/or text include representations of gauges (e.g., an image of a traditional altitude gauge). In addition, the same element of flight data 114, such as altitude, may be represented in the same overlay 128 by different modalities of representation, such as a number and a graphical bar that is filled proportionally. The overlay 128 is generated at intervals and thus dynamically represents the flight data 114 as the flight data 114 changes.

Generating the overlay 128 may additionally or alternatively include displaying video captured by the camera 106 of the UAV 102. As mentioned above, video captured by the UAV 102 may be from the perspective of the UAV 102, whether a fixed or aimable perspective, or may have a bird's eye view that is known to be generated from video of multiple viewpoints. A video overlay 128 may be combined with the real view with a picture-in-picture format.

Different overlays 128 may be generated for the pilot 108 to select before or during the flight.

Outputting the overlay 128 may include displaying the overlay 128 at the display device 120 of the headset computing device 104, so that both the overlay 128 and the real view 130 are visible and intelligible to the pilot 108. Representation of the flight data 114 may be positioned relative to the real view 130 at a location, such as at or near an outer perimeter of the real view, that reduces or minimizes obstruction of the real view and distraction to the pilot 108.

Accordingly, the system 100 provides to the pilot 108 with a real view of the UAV 102 augmented with a representation of important flight data 114, so that the pilot 108 may simultaneously visually monitor the UAV 102 and the flight data 114.

FIG. 1B shows an example system 150 that includes a UAV 102, a headset 152, and a computing device 154. The system 100 of FIG. 1A may be referenced for details not repeated here, with like reference numerals and terminology representing like components. Only differences between the systems 150 and 100 will be discussed in detail.

The headset 152 is connectable to the computing device 154 via a communications link 156, which may be wired or wireless. The headset computing device 104 may be a commercially available AR headset.

The computing device 154 may be a notebook computer, tablet computer, smartphone, or similar device. The computing device 154 may be under the control of the pilot 108 and located at the same location as the pilot 108.

The computing device 154 is configured to generate obtain the flight data 114 from the UAV 102, whether via direct wireless communications or via the remote control 110. The computing device 154 is further configured to generate an overlay 128, as discussed above. The computing device 154 is configured to output the overlay 128 to the headset 152, so that the overlay 128 may be combined with a real view 130. The computing device 154 may thus perform the overlay generation functionality discussed herein, while the headset 152 may combine the overlay 128 with the real view 130. Alternatively, in the case of a real view that is video, the computing device 154 may also combine the overlay 128 with the real view 130.

The system 150 may allow for reduced computational resources at the headset 152 and may allow for use of a wider range of off-the-shelf headsets.

The systems 100 and 150 discussed above provide different options for determination of flight data and generation of overlays of flight data. An overlay may be generated by a headset or by a computer connected to the headset. The overlay may be combined with a real view at the headset or at a computer connected to the headset. Other options are also contemplated. For example, an overlay may be generated by a computing device at the UAV, such as a flight computer or a computer that controls a camera of the UAV. In general, the functions of obtaining flight data and generating the overlay may be distributed among any of the headset, a computer connected to the headset, a remote control, the UAV, or other computing device that is in physical proximity to the flight. An overlay generated by a device other than the headset may be outputted to the headset for display. If the headset provides an optical real view, the headset combines the overlay with the real view. If the headset uses a video real view, combination of the overlay with the real view may be performed by the headset or by the device that generates the overlay, if not the headset.

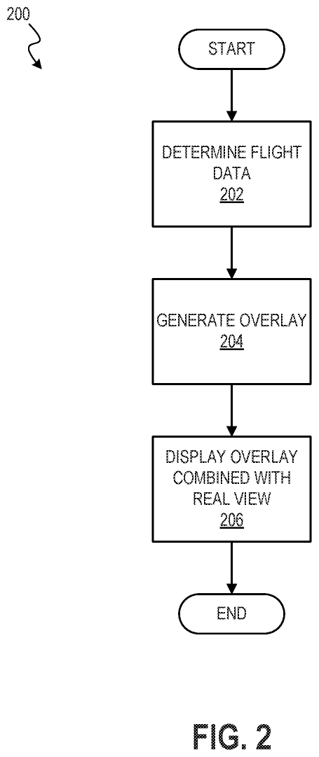

FIG. 2 shows an example method 200 of displaying flight data of a UAV. The method 200 may be implemented as processor-executable instructions, such as overlay instructions 126 discussed above. The above discussion of the systems 100, 150 may be referenced for details not repeated here.

At block 202, flight data of the UAV is determined. This may include receiving flight data wirelessly from the UAV. Received flight data may be raw data that is subsequently processed. Flight data may include altitude, speed, coordinates, power remaining, video, and similar operational data of the UAV.

At block 204, an overlay that describes the flight data is generated. The overlay may include graphics, symbols, text, video, or similar visual representations of the flight data.

At block 206, the overlay is displayed to a surface-based pilot of the UAV. The overlay is displayed as combined with a real view of the UAV, as may be enabled by a headset with a look-through optical path or a camera configured to capture video from the pilot's perspective.

The method 200 may be performed continuously in real time, such that the pilot is provided with a dynamic overlay of flight data at a rate of, for example, 24, 30, 60, etc. frames per second.

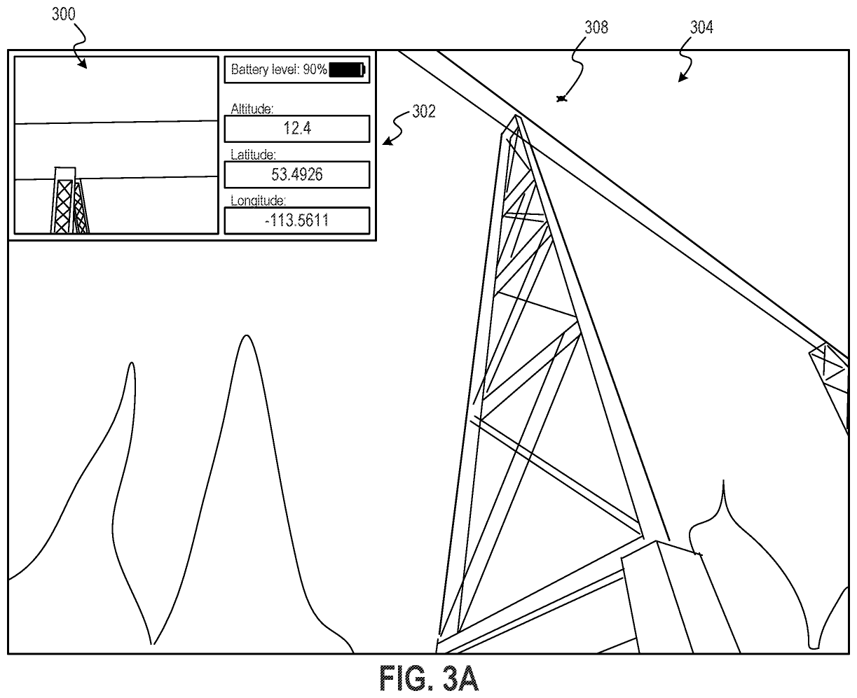

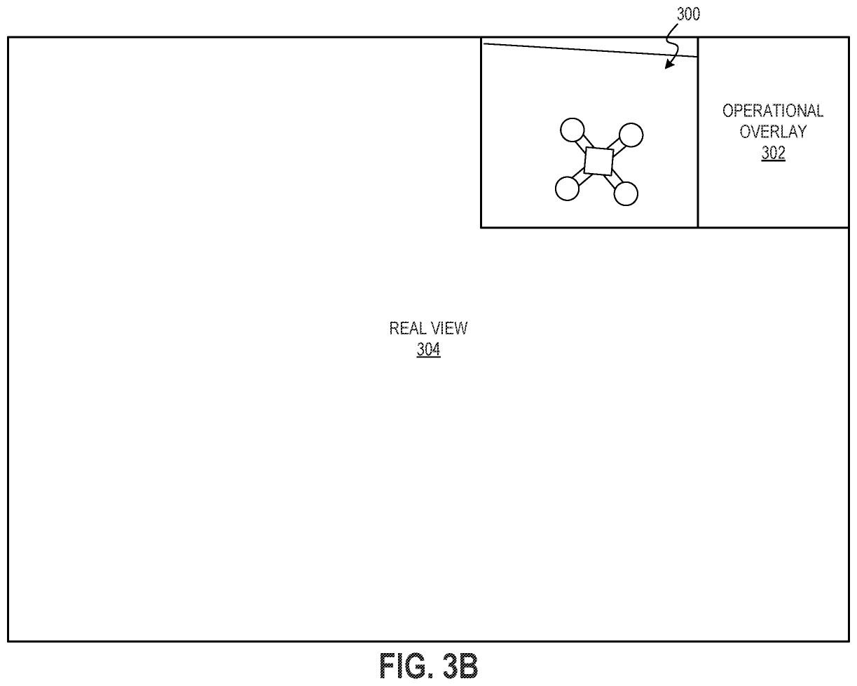

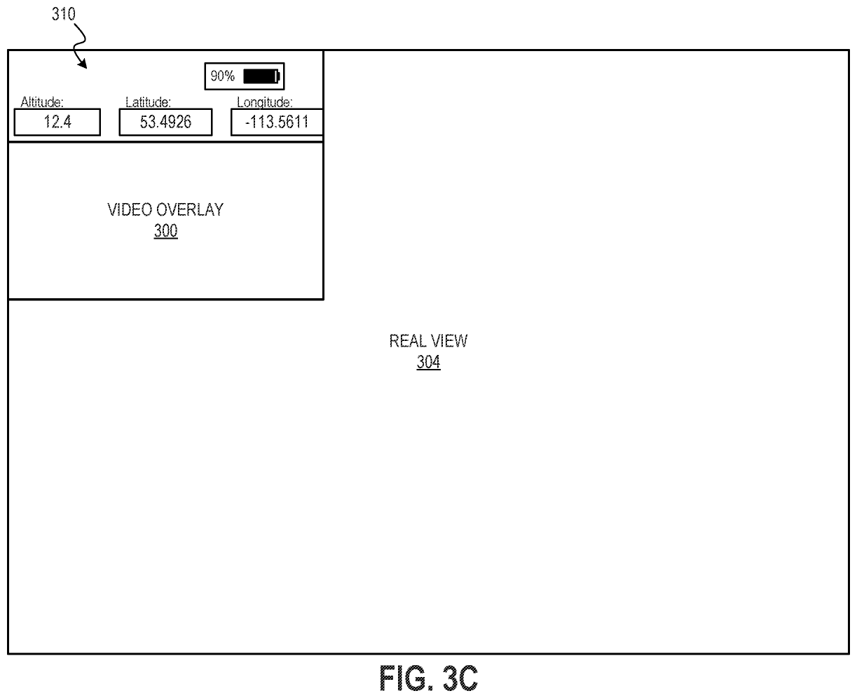

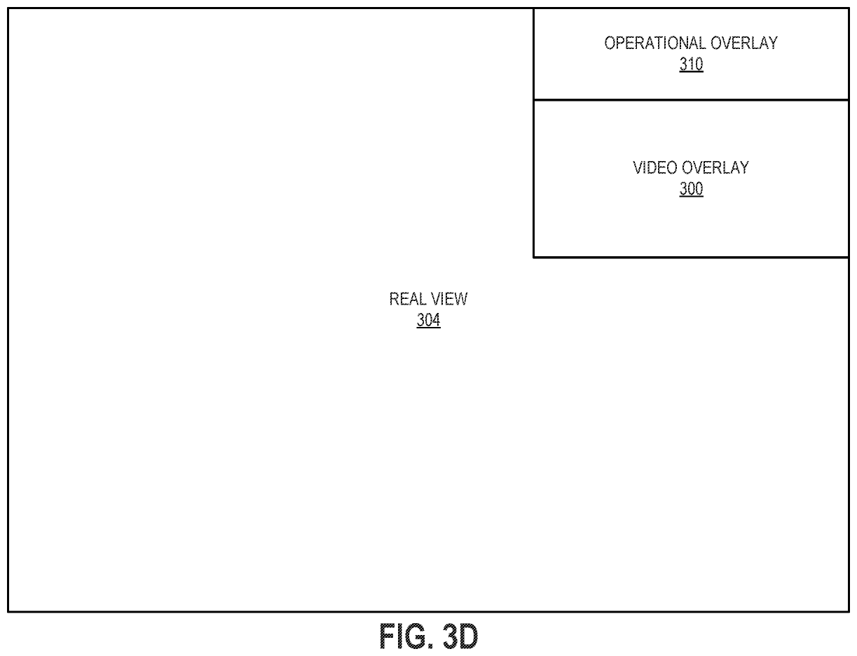

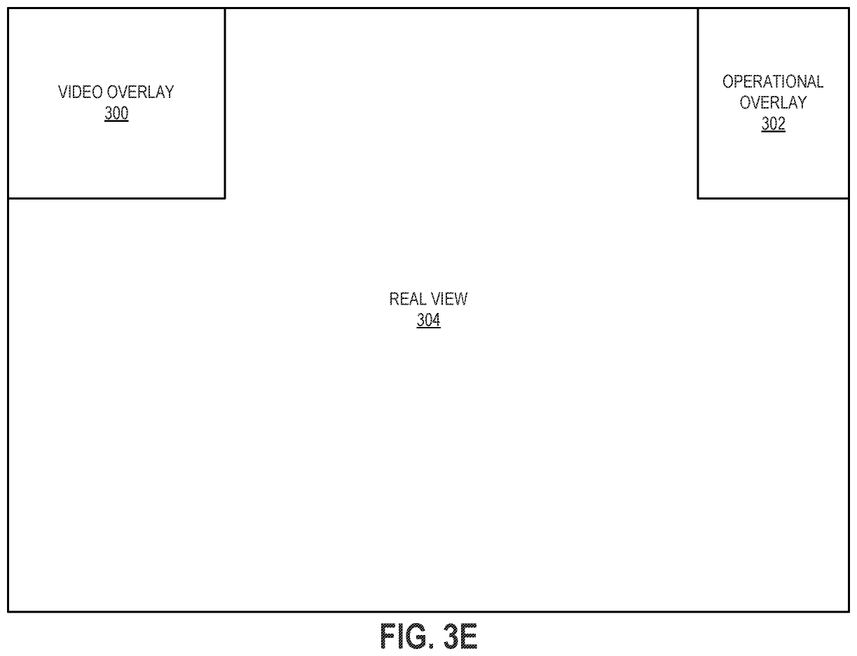

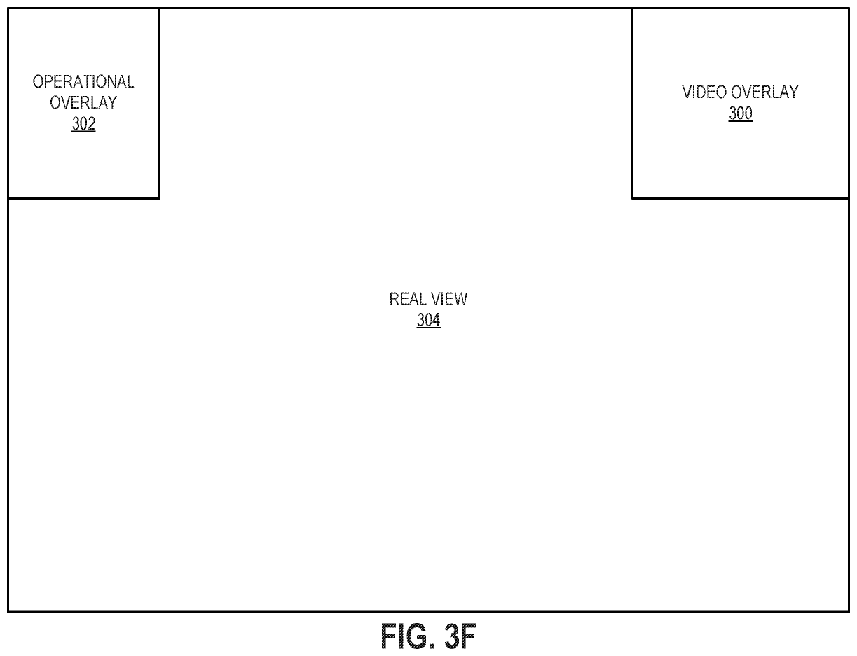

The overlays discussed herein may position the representation of flight data at a location within the real view that is readily visible to the pilot while reducing or minimizing obstruction or obscuring of the real view and while reducing or minimizing distraction or cognitive overload to the pilot. An overlay may be positioned at an edge or perimeter of the real view, such as at a top corner of the real view. Overlays containing different elements of flight data may be positioned adjacent to each other in the same corner or at opposing corners. An overlay may have an opaque background that occludes the underlying real view. A total area occupied by an overlay or multiple overlays displayed at the same time may be limited to less about than quarter of the original real view. FIGS. 3A-3F show examples of such overlays.

FIG. 3A shows example overlays 300, 302 combined with a real view 304. The overlays 300, 302 contain representations of flight data and are positioned at a top left of the real view 304. In this example, a video overlay 300 and an operational overlay 302 that includes numerical values, text, and symbols (e.g., battery life gauge) are horizontally adjacent to each other and located at a top-left position within the real view 304. Different data elements of the operational overlay 302 are vertically distributed.

As shown, the UAV 308 is visible in the real view at the same time that the flight data (e.g., UAV-perspective video, altitude, etc.) are visible in the overlays 300, 302. The pilot can monitor flight data presented in the overlays 300, 302 simultaneously with viewing the real view 304 that contains the UAV 308. As such, the pilot need not look away from the UAV 308 to view critical flight data. In this example, a bridge is being inspected via the UAV-perspective video presented in the overlay 300.

FIG. 3B shows example overlays 300, 302 combined with a real view 304. FIG. 3A and related description may be referenced for detail not repeated here. Example imagery is omitted for sake of clarity. In this example, a video overlay 300 and an operational overlay 302 that includes numerical values, text, and symbols (e.g., battery life gauge) are horizontally adjacent to each other and located at a top-right position within the real view 304. For sake of illustration, in this figure the video overlay 300 shows a bird's eye view of the UAV and nearby objects (e.g., the bridge).

FIG. 3C shows example overlays 300, 310 combined with a real view 304. FIG. 3A and related description may be referenced for detail not repeated here. Example imagery is omitted for sake of clarity. In this example, a video overlay 300 and an operational overlay 310 that includes numerical values, text, and symbols (e.g., battery life gauge) are vertically adjacent to each other and located at a top-left position within the real view 304. The operational overlay 310 includes data elements that are horizontal and vertically distributed.

FIG. 3D shows example overlays 300, 310 combined with a real view 304. FIGS. 3A and 3C and related description may be referenced for detail not repeated here. Example imagery is omitted for sake of clarity. In this example, a video overlay 300 and an operational overlay 310 that includes numerical values, text, and symbols (e.g., battery life gauge) are vertically adjacent to each other and located at a top-right position within the real view 304.

FIG. 3E shows example overlays 300, 302 combined with a real view 304. FIG. 3A and related description may be referenced for detail not repeated here. Example imagery is omitted for sake of clarity. In this example, a video overlay 300 and an operational overlay 302 that includes numerical values, text, and symbols (e.g., battery life gauge) are positioned at opposite top corners within the real view 304. The video overlay 300 is positioned at top left, and the operational overlay 302 is positioned at top right.

FIG. 3F shows example overlays 300, 302 combined with a real view 304. FIG. 3A and related description may be referenced for detail not repeated here. Example imagery is omitted for sake of clarity. In this example, a video overlay 300 and an operational overlay 302 that includes numerical values, text, and symbols (e.g., battery life gauge) are positioned at opposite top corners within the real view 304. The operational overlay 302 is positioned at top left, and the video overlay 300 is positioned at top right.

Aspects of the examples of FIGS. 3A-3F may be combined to arrive at different example overlay arrangements. In other examples, different flight data may be displayed. In still other examples, video may be omitted. In general, the overlays with flight data at one or more corners of the real view, and preferably one or both top corners, are contemplated to be less intrusive on the real view and more natural and less distracting for the pilot to monitor.

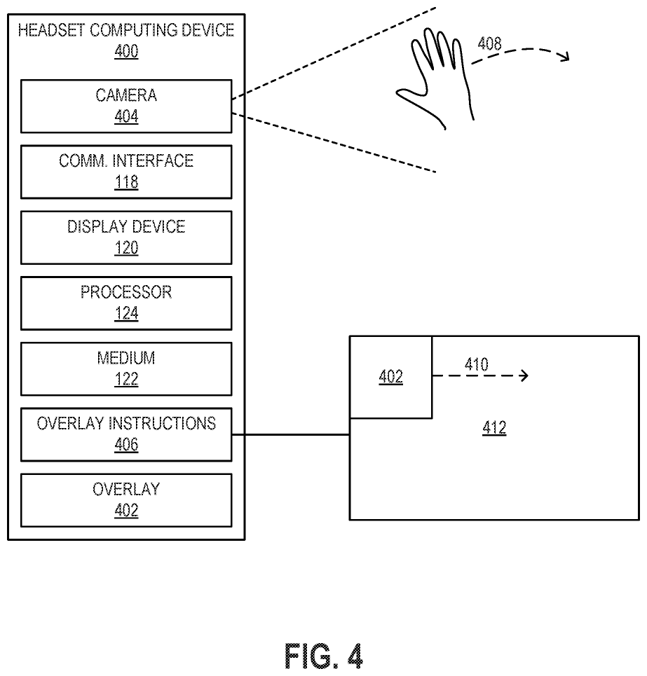

FIG. 4 is another example headset computing device 400 to display flight data with a movable overlay 402. The systems 100 and 150 of FIGS. 1A and 1B may be referenced for details not repeated here, with like reference numerals and terminology representing like components. Only differences will be discussed in detail.

The headset computing device 400 includes a camera 404 aimed forward to capture gestures, such as hand or finger gestures, made by the pilot. The camera 404 is connected to the processor 124.

The headset computing device 400 further includes overlay instructions 406 that carry out the functionality discussed above for the overlay instructions 126. The overlay instructions 406 are further configured to monitor imagery captured by the camera 404 to detect gestures 408 made by the pilot. The overlay instructions 406 configure the overlay 402, which is similar to the overlay 128 discussed above, based on gestures 408.

The overlay instructions 406 may define various gestures 408 to select, show/hide, and move any number of overlays 402. A gesture 408 may be defined to select a particular overlay 402 or cycle a selected overlay 402 among multiple available overlays 402 (e.g., overlays 300 and 302 discussed above).

Another gesture 408 may be defined to show or hide a selected overlay 402. Various different predefined overlays 402 may be provided for the pilot to selectively show or hide.

Another gesture 408 may be defined to move 410 a selected overlay 402 to a desired position within the real view 412. Multiple different gestures 408 may be provided to move 410 a selected overlay 402 in different directions or to different predefined positions within the real view 412. Overlay motion may be freeform, in that a gesture 408 moves 410 the overlay proportional to the gesture. Overlay motion may be discrete, in that a gesture 408 cycles through discrete predefined overlay positions.

In another example, a single gesture 408 cycles through several predefined overlay configurations that have various different predefined overlays 402 at various different predefined positions. For example, the overlay configurations of FIGS. 3A-3F may be predefined and a predefined single hand gesture 408 may be predefined to cycle through these overlay configurations. A configuration without any overlays may also be added to the cycle.

As such, the pilot may configure one or more overlays 402 based on their preference.

In view of the above, it should be apparent that the techniques discussed herein allow the viewing of flight data without looking away from the UAV. A computing device, whether a headset, connected computer, or the UAV itself, may be used to generate an augmented reality or AR view of flight data in the context of a real view of the UAV. Accordingly, UAV flights may be made safer and/or more efficient.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by one or more processors, cause the one or more processors to collectively:
determine flight data of an unmanned aerial vehicle that is controllable by a surface-based pilot;
generate an overlay that describes the flight data; and
display to the surface-based pilot the overlay combined with a real view of the unmanned aerial vehicle.

2. The non-transitory machine-readable medium of claim 1, wherein the instructions are further to render the flight data as a graphic, symbol, text, or combination of such.

3. The non-transitory machine-readable medium of claim 2, wherein the flight data comprises:
a remaining energy of the unmanned aerial vehicle;
an altitude of the unmanned aerial vehicle;
a latitude of the unmanned aerial vehicle;
a longitude of the unmanned aerial vehicle; or
a combination of such.

4. The non-transitory machine-readable medium of claim 1, wherein:
the flight data comprises video captured by a camera of the unmanned aerial vehicle; and
the instructions are further to display the video combined with the real view of the unmanned aerial vehicle.

5. The non-transitory machine-readable medium of claim 4, wherein the video has a bird's eye view of the unmanned aerial vehicle.

6. The non-transitory machine-readable medium of claim 4, wherein the video is taken from a perspective of the unmanned aerial vehicle.

7. The non-transitory machine-readable medium of claim 1, wherein the instructions cause the one or more processors to collectively generate the overlay with the flight data at a top-left position within the real view.

8. The non-transitory machine-readable medium of claim 1, wherein the instructions cause the one or more processors to collectively generate the overlay with the flight data at a top-right position within the real view.

9. The non-transitory machine-readable medium of claim 1, wherein the instructions cause the one or more processors to collectively:
render a portion of flight data as a graphic, symbol, text, or combination of such at one of a top-left position and a top-right position within the real view; and
render another portion of the flight data as video at another of the top-left position and the top-right position within the real view.

10. The non-transitory machine-readable medium of claim 1, wherein the instructions cause the one or more processors to collectively generate the overlay in which the flight data occupies less than one quarter of the real view.

11. A device comprising:
a communications interface;
one or more processors connected to the communications interface, the one or more processors configured to collectively:
determine flight data of an unmanned aerial vehicle that is controllable by a surface-based pilot;
generate an overlay that describes the flight data; and
output the overlay for combination with a real view of the unmanned aerial vehicle.

12. The device of claim 11, wherein:
the flight data comprises a remaining energy of the unmanned aerial vehicle, an altitude of the unmanned aerial vehicle, a latitude of the unmanned aerial vehicle, a longitude of the unmanned aerial vehicle, or a combination of such; and
the one or more processors are configured to collectively render the flight data as a graphic, symbol, text, or combination of such.

13. The device of claim 11, wherein:
the flight data comprises video captured by a camera of the unmanned aerial vehicle; and
the one or more processors are configured to collectively display the video combined with the real view of the unmanned aerial vehicle.

14. The device of claim 11, wherein:
the communications interface comprises a wireless communications interface; and
the wireless communications interface is configured to receive the flight data from the unmanned aerial vehicle.

15. The device of claim 14, further comprising a display device connected to the one or more processors, wherein the display device is configured to display the overlay combined with the real view of the unmanned aerial vehicle.

16. The device of claim 11, wherein the one or more processors are configured to move the overlay within the real view.

17. The device of claim 16, further comprising:
a camera connected to the one or more processors;
wherein the one or more processors are configured to detect a gesture of the surface-based pilot using the camera and to move the overlay within the real view based on the gesture.

18. A method comprising:
determining flight data of an unmanned aerial vehicle while the unmanned aerial vehicle is under control of a surface-based pilot;
generating an overlay that describes the flight data; and
displaying to the surface-based pilot the overlay combined with a real view of the unmanned aerial vehicle.

19. The method of claim 18, wherein:
the flight data comprises a remaining energy of the unmanned aerial vehicle, an altitude of the unmanned aerial vehicle, a latitude of the unmanned aerial vehicle, a longitude of the unmanned aerial vehicle, or a combination of such; and
the method further comprises rendering the flight data as a graphic, symbol, text, or combination of such.

20. The method of claim 18, wherein:
the flight data comprises video captured by a camera of the unmanned aerial vehicle; and
the method further comprises displaying the video combined with the real view of the unmanned aerial vehicle.
